(19) United States
(12) Patent Application Publication
(10) Pub. No.: US 2004/0247968 A1
(43) Pub. Date: Dec. 9, 2004

(54) Fuel cell with cooling system

(76) Inventors: Frank Brenner, Remseck (DE); Thomas Heid, Renchen-Ulm (DE); Bernhard Denne, Offenburg (DE)

Correspondence Address: STRIKER, STRIKER & STENBY, 103 East Neck Road, Huntington, NY, 11743, US

(21) Appl. No.: 10/843,846

(22) Filed: May 12, 2004

(30) Foreign Application Priority Data
Jun. 6, 2003 (DE) 103 25 444.7

(51) Int. Cl. H01M 8/04

(52) U.S. Cl. 429/26; 429/24; 429/22

(57) ABSTRACT

A fuel cell device has a fuel cell, a cooling unit for cooling the fuel cell, and a connecting unit for connecting the cooling unit to a cooled or air conditioned space for use of a space waste air for cooling.

### BACKGROUND OF THE INVENTION

The present invention relates to a fuel cell device, in particular including a fuel cell with a cooling system.

Fuel cell systems, such as for example BZ-drive+APU(auxiliary power unit), are cooled through a conventionally designed cooling system with components, such as those used for cooling of combustion engines. The significant difference is however that the cooling system of a fuel cell system with a power comparable to a combustion engine, must be designed significantly greater (for example fan power, cooler surface), since the temperature level of the waste heat of the fuel cell system is substantially lower than in the combustion engine. Thereby the temperature difference with respect to outside air, to which the waste heat is withdrawn through the cooling system, is substantially smaller.

The action of the lower temperature difference is demonstrated in that the efficiency of a fuel cell system or a fuel cell device is always worse, with lower temperature difference between the cooling air and the surrounding air.

### SUMMARY OF THE INVENTION

Accordingly, it is an object of the present invention to provide a fuel cell with a cooling system, which eliminates the disadvantages of the prior art.

More particularly, it is an object of the present invention to provide a fuel cell with a cooling system, which provides an improved cooling power for the fuel cells.

In keeping with these objects and with others which will become apparent hereinafter, one feature of the present invention resides, briefly stated in a fuel cell device, comprising a fuel cell and cooling means for cooling said fuel cell, wherein connecting means is provided for connecting said cooling means to a cooled and/or air conditioned space to use a space waste air for cooling.

The inventive device is characterized in that, for increase of the temperature difference between cooling air and surrounding air in an available cooled or air conditioned space, the cooled or air conditioned waste air of the space is used for increase of the temperature difference between cooling air and surrounding air, to obtain a power improvement of the fuel cell device.

For this purpose the following considerations are valid. In a fuel cell system a lost heat produced during the energy conversion from hydrogen to oxygen must be withdrawn from the system. This is conventionally guaranteed by a closed cooling medium circuit. The cooling medium is brought to a lower temperature level as a rule with the use of fans.

Generally at this stage it should be mentioned that the fuel cell systems or fuel cell system devices can be used both in a stationary version and a mobile version. The present invention is applicable both for the stationary and for the mobile operation of the fuel cell systems of fuel cell devices, which are operated in connection with the cooled or air conditioned space. They have an improved efficiency when compared with commercially cooled fuel cell systems of fuel cell devices, since additionally to surrounding air which is used as cooling air, at least a certain part of the cooled or air conditioned waste air of a cooled or air conditioned space is used as well.

The present invention is illustrated as an embodiment that is used for corresponding applications, for example for a vehicle. By mixing the waste air from the cooled/air conditioned passenger compartment to cooling air from the environment, the temperature of the cooling air stream can be lowered. The admixing can be performed by a regulatable passenger space ventilation.

With the use of air conditioning devices, both in buildings and in passenger spaces of vehicles, a constant “low” temperature level within narrow limits is provided, in particular at high, cooling power-critical outer temperatures. The waste air from the cooled/air conditioning spaces or the vehicle passenger space is controlled by a regulatable inner space circulation of the cooling air from the environment in a mixing line before the cooler inlet. Thereby the cooling air temperature before the inlet in the cooler is lowered. As a result the cooling air fan can be designed in some cases smaller, since the greater temperature difference of the cooling air with respect to the cooling medium temperature requires a lower cooling air consumption. In particular, with high outer temperatures, the inner space air which is discharged to environment is efficiently utilized for cooling.

In a circulating operation of the air conditioning device, a short-time opening of the regulatable inner space aeration can absorb cooling power picks of the BZ system.

In accordance with a special embodiment of the invention, the improvement of cooling of the fuel cell is used for a mobile application. For this purpose, for example an embodiment in a vehicle is provided.

With the use of the vehicle air conditioning device, low temperature surrounding air is supplied into the vehicle passenger space, which as a rule is withdrawn outwardly in the rear region of the vehicle passenger space through ventilation openings. This waste air can be connected through communications, for example in the form of passages with a integrated regulatable inner space aeration and supplied to a mixing chamber. By means of a fan, the mixed air is supplied to the cooler for the fuel cell system. The regulating ability of the aeration and admixture operation is provided by a throttle or flap device that is controlled by a motor. The amount of the admixed cooling air of the vehicle passenger space is in the order of the cooling mass stream required for the cooling of a BZ-APU.

For regulation of the admixing operation, the throttle and flap device can supply the total space air to the mixing chamber, in which the the space waste air is mixed with the surrounding air and subsequently supplied to the cooler.

It is however possible to discharge a part of the total space waste air by the throttle or flap device directly into the surrounding air without supplying into the mixing chamber.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a fuel cell with a cooling system in accordance with the present invention.

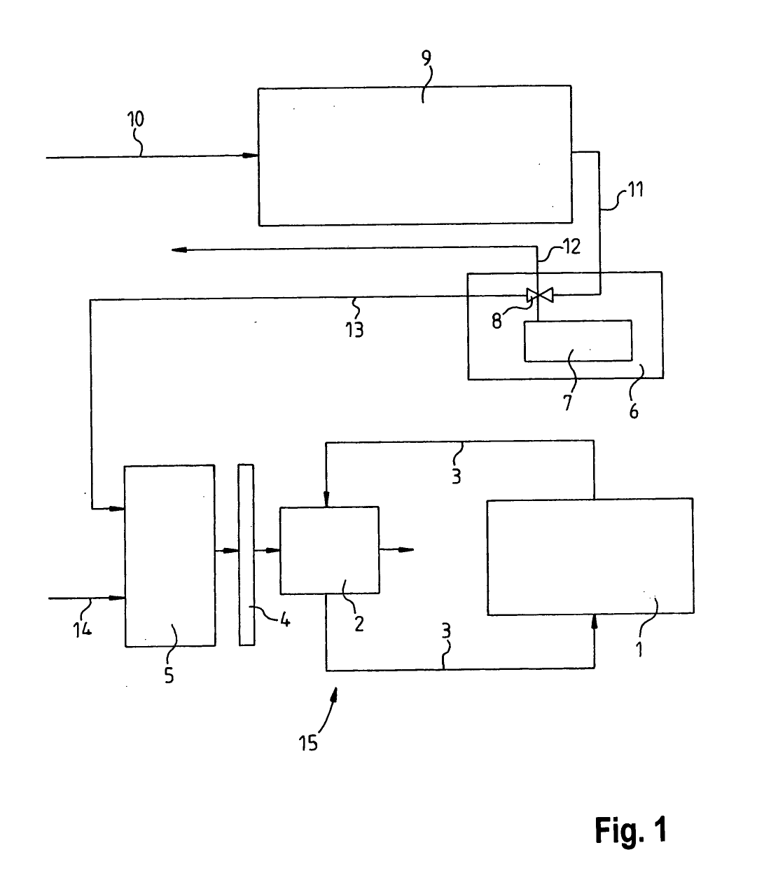

### DESCRIPTION OF THE PREFERRED EMBODIMENTS

A fuel cell device is identified with reference numeral 15 and has a fuel cell 1. A space waste air 11 of a cooled or air conditioning space 9 is used for additional cooling and thereby for increase of the temperature difference in the cooling system.

The fuel cell 1 is cooled by a cooling medium stream 3. A cooling medium stream 3 flows both through the fuel cell 1 and also through a corresponding cooler 2. Such cooling circuits are known. It is also known to supply surrounding air 14 by a fan 4, so that the cooling fluid, that flows through it, is correspondingly cooled.

In accordance with the present invention, in addition to the surrounding air 14 which is used as a cooling air in a conventional manner, the air stream of the space waste air 11 of a cooled or an air conditioned space 9 is supplied to a mixing chamber 5. In the mixing chamber 5 the surrounding air 14 is mixed with the space waste air 11. This mixture of the surrounding air 14 and the space waste air 11 is supplied by a fan 4 of the cooler.

With the inventive admixture of the space waste air 11, a cooling air with a lower temperature than the normal surrounding air is provided for the cooler 2 and thereby for the cooling system of the fuel cell 1. Thereby in accordance with the present invention, an increased temperature difference for the cooling system of the fuel cell 1 is obtained with a resulting higher efficiency, so that in some cases smaller components for the cooling system of the fuel cell device can be utilized.

With the use of smaller or lower power elements in the cooling system of the fuel cell device, several advantages are provided. One advantage resides in that the system can be smaller, so that it can be accommodated in a vehicle in a simple and easy manner. Another advantage is of course the reduction of the manufacturing and operational costs.

In connection with the example in which the present invention is used in a vehicle, a less usable space for the cooling system can be lost in accordance with the present invention.

The fuel cell device 15 with the fuel cell 1 and the cooler 2 are cooled in accordance with the present invention with the cooled or air conditioned spaced waste air 11 at least additionally to the surrounding air. The cooled or air conditioned space waste air comes from the ventilation system for the air conditioning space 9, which is supplied with air conditioned air 2 by an air conditioning device. By the supply with air conditioned air 10, the air condition space 9 is held more or less at a constant temperature, which has a higher temperature difference with respect to the surrounding air with the increase of the temperature of the surrounding air.

This means that in accordance with the present invention, the already cooled air is advantageously used to supply the cooling system for the fuel cell 1 with cooling air of lower temperature than it is possible by the surrounding air. In particular, at high outside temperatures of the surrounding air, the admixture of the cooled or air conditioned space waste air 11 acts advantageously on the cooling system of the fuel cell 1. This is especially true since with increasing outer temperature of the surrounding air 14 the efficiency of the fuel cell without such admixture becomes lower. The inventive admixture of the cooled or air conditioned space waste air 11 counteracts this tendency.

For regulating or controlling the admixture of the cooled or air conditioned space waste air 11 to the surrounding air 14, a throttle or flap device 8 is arranged in a connection 6 between the waste air system of the air condition space 9 and the input in the mixing chamber 5. The throttle or flap device 8 can be actuated in a controlled or regulated manner. The actuation of the throttle or flap device 8 can be performed for example by an adjusting drive 7.

The operation of the throttle or flap device 8 is such that either the total space waste air 11 is supplied further to the mixing chamber 4, or a part of the space waste air is branched as a not used space waste air 12 and discharged into environment. It can be further provided that the total space waste air 11 is withdrawn not as used space waste air 12 predominantly, or in predetermined time periods is not withdrawn to the mixing chamber 5, but instead into environment.

Furthermore, a regulation is provided for regulating or controlling the adjustment of the throttle and flap device, depending on the operational condition of the fuel cell device 15 and/or the temperature of the space waste air 11.

In accordance with a further feature of the present invention it can be provided that either the same regulation or an additional regulation is provided, so that during a circulation operation of the cooled or air conditioned space 9, from time to time, in some cases repeatedly, the air circulating operation is converted into an aeration operation. Therefore, for the cooling circuit of the fuel cell device 15, in additional to the cooling by the surrounding air, additional cooling for the fuel cell 1 is guaranteed. This is especially applicable when the efficiency of the fuel cell starts to drop due to a lower temperature difference. Then the circulation operation is converted into an aeration operation and thereby a further lowering of the efficiency for the fuel cell 1 is prevented or an improvement of the efficiency of the fuel cell 1 is obtained.

It will be understood that each of the elements described above, or two or more together, may also find a useful application in other types of constructions differing from the types described above.

While the invention has been illustrated and described as embodied in fuel cell with cooling system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A fuel cell device, comprising a fuel cell; cooling means for cooling said fuel cell, and connecting means for connecting said cooling means to a cooled or air conditioned space for use of a space waste air for cooling.

2. A fuel cell device as defined in claim 1, wherein said fuel cell device is a fuel cell device arranged in a vehicle.

3. A fuel cell device as defined in claim 1, wherein said fuel cell device is a fuel cell device arranged in at least one building.

4. A fuel cell device as defined in claim 1; and further comprising a mixing chamber for mixing of the space waste air of the cooled and/or air conditioned space with a surrounding air.

5. A fuel cell device as defined in claim 4; and further comprising a throttle or flap device for controlling and/or regulating a supply of the space waste air to said mixing chamber.

6. A fuel cell device as defined in claim 4; and further comprising controlling or regulating means for supply of the space waste air to said mixing chamber depending on operational conditions of the fuel cell device and/or a temperature of the space waste air.

7. A fuel cell device as defined in claim 5, wherein said throttle or flap device is provided with an adjusting drive for control or regulation of said throttle or flap device.

8. A fuel cell device as defined in claim 1; and further comprising means for controlling or regulation which, for a case when a cooling or air conditioning device is set for a circulating operation converts the operation for a predetermined time or repeatedly from the circulating operation to an aerating operation, so that for a cooling circuit of the fuel cell device an additional cooling is provided.

9. A fuel cell device as defined in claim 5; and further comprising a connection between the cooled or air conditioned space and said cooler, said throttle or flap device being arranged on said connection.

10. A fuel cell device as defined in claim 5, wherein said throttle or flap device is formed so as to the space waste air and to supply it to an element selected from the group consisting of a mixing chamber and an environment.
